(19) United States
(12) Patent Application Publication
(10) Pub. No.: US 2005/0052863 A1
(43) Pub. Date: Mar. 10, 2005

(54) Structure for engaging light emitting diode of rotational information display device

(76) Inventors: Seongukk Kim, Seoul (KR); Hyewon Baen, Seoul (KR); Sean Lee, Huntington, NY (US)

Correspondence Address: WELLS ST. JOHN P.S., 601 W. FIRST AVENUE, SUITE 1300, SPOKANE, WA, 99201, US

(21) Appl. No.: 10/660,407

(22) Filed: Sep. 10, 2003

(51) Int. Cl. F21S 2/00

(52) U.S. Cl. 362/232

(57) ABSTRACT

The present invention relates to a light emitting diode engaging structure in which it is not needed to use a wire when electrically connecting a controller adapted to control an on and off of a light emitting diode and a light emitting diode in such a manner that the light emitting diodes capable of displaying a 3D information or image in an atmosphere space based on an afterimage effect during a rotation are engaged in a patterned PCB. In a rotational information display device which includes a housing, a motor installed in the housing and driven when a power is supplied, a light emitting diode rotation frame engaged to a rotary shaft of the motor, and light emitting diodes installed in the light emitting diode support fixed to the light emitting diode rotation frame for thereby displaying a 3D information or image during a rotation, there is provided a structure for engaging a light emitting diode in a rotational information display device, comprising a first substrate which is fixed to the light emitting diode rotation frame and includes a controller for controlling a power supply to the light emitting diodes and an on and off operation and a plurality of first pattern portions formed on a surface of the same; and a second substrate which includes a second pattern portion electrically connected with the first pattern portion, and a plurality of light emitting diodes electrically connected between the second pattern portions, the second substrate being electrically connected with the first substrate.

### BACKGROUND OF THE INVENTION

1. Field of the Invention

The present invention relates to a structure for engaging a light emitting diode of a rotational information display device in which it is not needed to use a wire for transferring an electric signal to a light emitting diode for controlling an on and off of a light emitting diode adapted to display a certain 3D information or image in an atmosphere space based on an afterimage effect during a rotation, and in particular to a structure for engaging a light emitting diode of a rotational information display device which is capable of electrically connecting a controller adapted to control an on and off of a light emitting diode and a light emitting diode without using a certain wire in such a manner that a plurality of light emitting diodes capable of displaying a 3D information or image in an atmosphere space during a rotation are engaged in a patterned printed circuit board (PCB).

2. Description of the Background Art

An afterimage effect is directed to a visual memory phenomenon which has an illusion for a certain time period like a certain image actually remains in a memory, among the phenomena that a human can recognize visually. A rotational display device capable of displaying a 3D information or image in an atmosphere space by rotating a certain light source such as a light emitting diode, etc. using the above afterimage effect is developed and adapted for a commercial purpose.

Generally, an optical semiconductor device (referred to light emitting diode) is an element for performing an optical transfer through an electrical signal and is classified into a common light emitting device (350 nm˜990 nm) which transforms an electrical signal into an optical signal by a light emitting diode and uses the same as a forward output, and a light receiving device (photo transistor, photo diode, photo IC, etc.) capable of receiving an optical signal and transforming the signal into an electrical signal. In the above semiconductor device, various wavelength products such as a UV light, visual light, infrared red light, etc. are manufactured based on the material of a semiconductor and the kinds and concentration of a PN junction and a structure of the same.

As shown in FIG. 1, the conventional rotational information display device includes an upper side opened box shaped housing 1, a motor 2 which is installed in the housing 1 and is driven when a power is supplied thereto, a light emitting diode rotation frame 3 which is engaged in a rotary shaft 2a of the motor 2 and is rotated, a light emitting diode support which is fixed to the rotation frame 3 and has a light emitting diode 4 for thereby displaying a certain 3D information during a rotation, a first controller (control PCB) 9 for controlling an on and off of the light emitting diode 4, a second controller (LED PCB) 8 which is electrically connected with the first controller 9 by a connector for thereby supplying a power to the light emitting diode 4, a third controller (power PCB) 15 for supplying a commercial power to the second controller 8, and a contactor 11 which communicates with a brush 10 supported by the third controller 15 and is insulated by an insulator in the rotary shaft 2a for supplying a commercial power to the second controller 9 during the operation of the motor 2.

The above light emitting diode support includes a first light emitting diode support 5 which has a light emitting diode 4 provided in a circle shape and has a spherical information display surface during the rotation, a second light emitting support 6 which is provided in a portion opposite to the first light emitting diode support 5 by a certain distance from the rotary shaft 2a in a radius direction and has the light emitting diodes 4 arranged in a straight line shape and a stripe shaped cylindrical information display surface provided outside the spherical information display surface, and a third light emitting diode support 7 in which the light emitting diode 4 is arranged between the first and second light emitting diode supports 5 and 6 in a straight line shape. In addition, the third light emitting diode support 7 has a stripe shaped cylindrical information display surface inside the spherical information display surface during a rotation.

When the power is supplied to the motor 2, and the light emitting diode rotation frame 3 is rotated, the power is supplied to the light emitting diodes 4 provided in the first, second and third light emitting diode supports 5, 6 and 7 integrally fixed to the light emitting diode rotation frame 3, so that a 3D information or image is displayed in an atmosphere space.

FIG. 2 is a view illustrating a light emitting diode engaging structure in a conventional rotational information display device.

Insertion holes (not shown) are formed in the first, second and third light emitting supports 5, 6 and 7 for fixing the light emitting diode 4 adapted to display a 4D information in an atmosphere space during a rotation to the first, second and third supports 5, 6 and 7, respectively, and the light emitting diodes 4 are inserted and fixed by a lead welding method. Both ends of the wire 12 are lead-welded to the light emitting diode 4 and the second controller 8 for supplying the power from the second controller 8 to the light emitting diode 4, and then the first, second and third supports 5, 6 and 7 are molded using an epoxy resin.

Namely, in the conventional art, the insertion holes are formed in the first, second and third supports 5, 6 and 7 which are formed in a thin thickness for fixing the light emitting diodes 4, and then the light emitting diodes 4 are inserted into the insertion holes and are manually fixed by the lead-welding method. Therefore, the productivity is decreased by its difficult work procedure. In addition, the work time and work process are increased, so that the productivity is significantly decreased. The fabrication cost and the price of the product are increased.

In addition, it is impossible to accurately display a 3D information in an atmosphere space due to a certain error which may occur in the case that the wire 12 is lead-welded to the light emitting diodes 4, respectively, and the wire 12 is disconnected during the use of the same, so that a reliability of the product is decreased.

In the conventional art, the fixture and arrangement of the light emitting diodes 4 engaged to each light emitting diode support are bad, and the luminance of the light emitting diode 4 is degraded. Therefore, the sharpness of the image is decreased, and the reliability of the product is decreased.

### SUMMARY OF THE INVENTION

Accordingly, it is an object of the present invention to provide a structure for engaging a light emitting diode of a rotational information display device which does not need a wire when connecting a controller adapted to control an on and off of a light emitting diode and a light emitting diode by engaging a plurality of light emitting diodes capable of displaying a 3D information in an atmosphere space during a rotation to a patterned printed circuit board. Therefore, the work process is decreased, and it is possible to significantly decrease the fabrication cost based on a mass production.

It is another object of the present invention to provide a structure for engaging a light emitting diode of a rotational information display device which is capable of implementing an accurate 3D information or image and higher sharpness and enhancing a reliability of a product for thereby obtaining a desired compatibility in such a manner that the light emitting diodes are accurately fixed with respect to the patterned printed circuit board.

It is further another object of the present invention to provide a structure for engaging a light emitting diode of a rotational information display device which is capable of significantly increasing a workability by decreasing a work time and work process needed for fixing the light emitting diodes to a patterned printed circuit board.

It is still further another object of the present invention to provide a structure for engaging a light emitting diode of a rotational information display device which is capable of freely implementing a 3D image like a natural image, a graphic processed image or character using a surface mounting device (SMD) light emitting diode in which a RGB may be combined for a light emitting diode.

To achieve the above objects, in a rotational information display device which includes a housing, a motor installed in the housing and driven when a power is supplied, a light emitting diode rotation frame engaged to a rotary shaft of the motor, and light emitting diodes installed in the light emitting diode support fixed to the light emitting diode rotation frame for thereby displaying a 3D information or image during a rotation, there is provided a structure for engaging a light emitting diode in a rotational information display device, comprising a first substrate which is fixed to the light emitting diode rotation frame and includes a controller for controlling a power supply to the light emitting diodes and an on and off operation and a plurality of first pattern portions formed on a surface of the same; and a second substrate which includes a second pattern portion electrically connected with the first pattern portion, and a plurality of light emitting diodes electrically connected between the second pattern portions, the second substrate being electrically connected with the first substrate.

In addition, the second substrate is formed of an elastically flexible printed circuit board.

The light emitting diodes engaged on the second substrate are formed of a plurality of SMD light emitting diodes which may be combined based on RGB colors.

To achieve the above objects, in a rotational information display device which includes a housing, a motor installed in the housing and driven when a power is supplied, a light emitting diode rotation frame which is engaged to a rotary shaft of the motor and is rotated, light emitting diodes which are provided in the light emitting support fixed to the light emitting diode rotation frame for thereby displaying a 3D information or image in an atmosphere space during a rotation, and a controller fixed to the rotary shaft for controlling an on and off of the light emitting diodes, there is provided a structure for engaging a light emitting diode of a rotational information display device, comprising a patterned printed circuit board (PCB) which is electrically connected with the controller and fixed to the light emitting diode rotation frame, and in the patterned PCB, the light emitting diodes are inserted into the through holes and are lead-welded in the back surface, so that the power and electrical signal from the controller are transferred to the light emitting diodes.

### BRIEF DESCRIPTION OF THE DRAWINGS

The present invention will become better understood with reference to the accompanying drawings which are given only by way of illustration and thus are not limitative of the present invention, wherein;

FIG. 1 is a separate perspective view illustrating a conventional rotational information display device;

FIG. 2 is a view illustrating a major element of a light emitting diode engaging structure in a conventional rotational information display device;

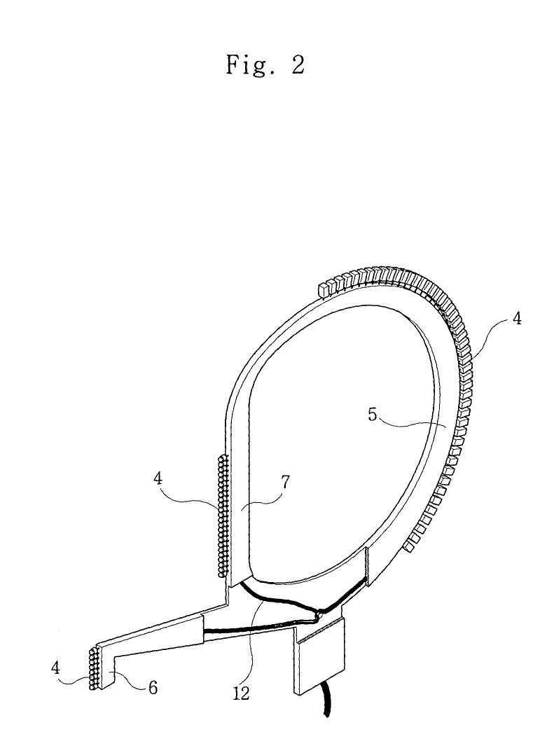

FIG. 3 is a view illustrating a rotational information display device according an embodiment of the present invention;

FIG. 4 is a view illustrating a printed circuit board having a light emitting diode in a rotational information display device according to an embodiment of the present invention;

FIG. 5 is a view illustrating a state that a light emitting diode is engaged to a printed circuit board in a rotational information display device according to an embodiment of the present invention;

FIG. 6 is a view illustrating a major element of a light emitting diode engaging structure according to another embodiment of the present invention; and

FIG. 7 is a view illustrating a state that a light emitting diode is engaged to a printed circuit board according to another embodiment of the present invention.

### DETAILED DESCRIPTION OF THE PREFERRED EMBODIMENTS

The preferred embodiments of the present invention will be described with reference to the accompanying drawings.

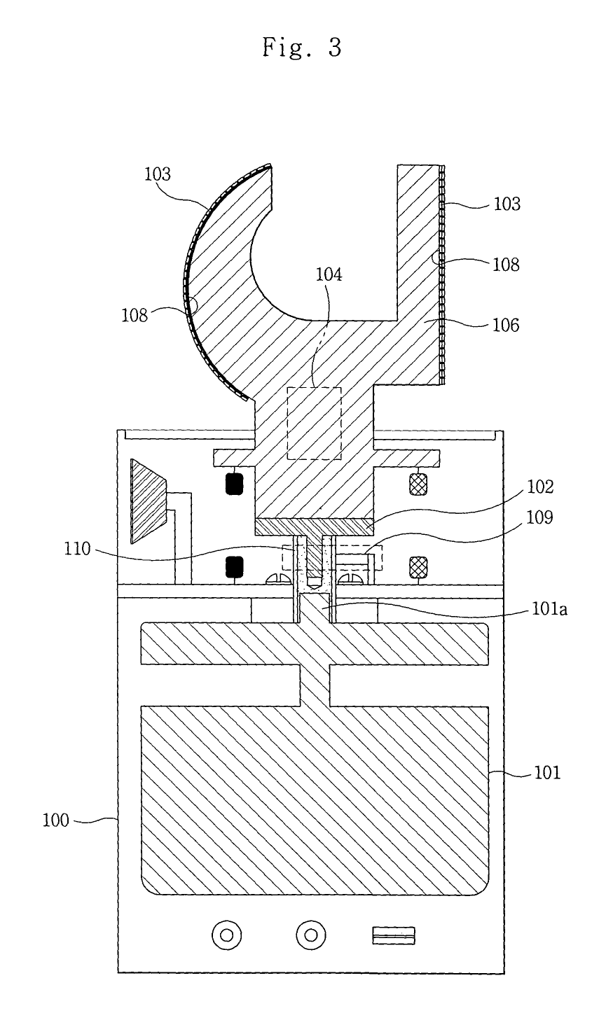

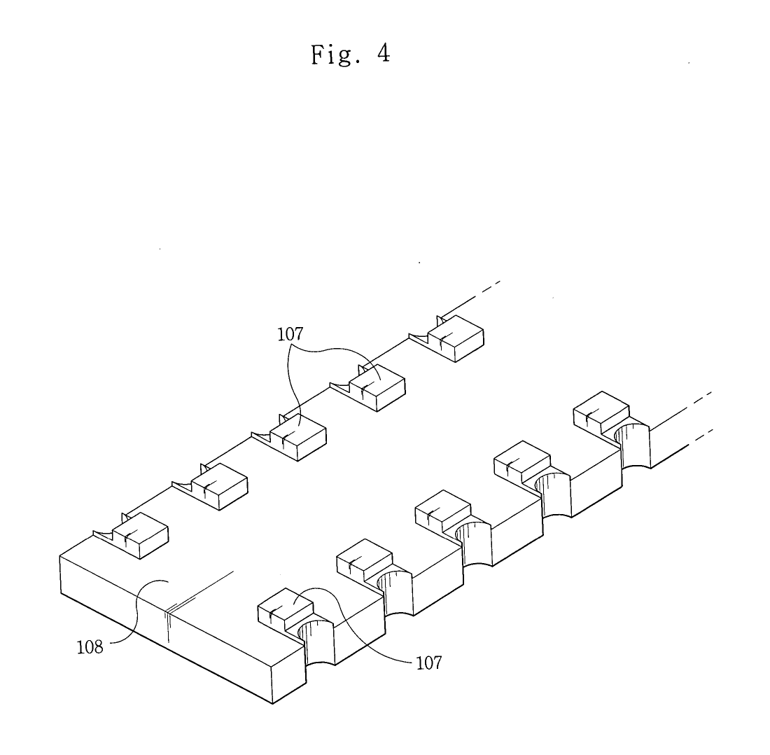

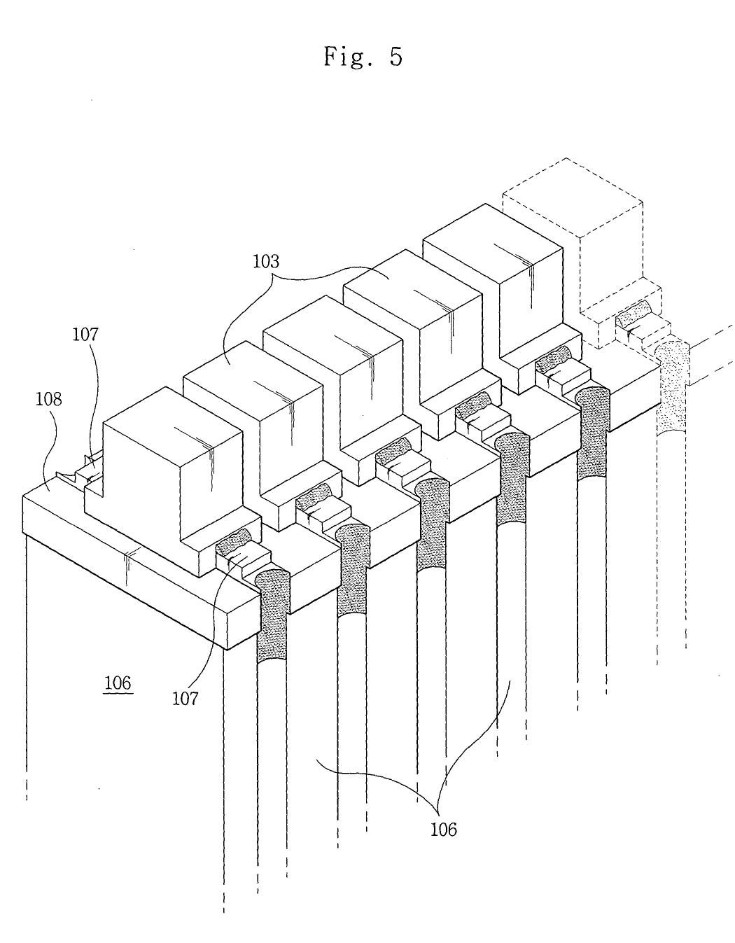

As shown in FIGS. 3 through 5, the structure for engaging a light emitting diode in a rotational information display device according to an embodiment of the present invention is adapted to a rotational information display device which includes a housing 100, a motor 101 installed in the housing 100 and driven when a commercial power is supplied, a light emitting diode rotation frame 102 which is engaged to a rotary shaft 101a of the motor 101 and is rotated, and a light emitting diode 103 provided in the light emitting diode support fixed to the light emitting diode rotation frame 102 for displaying a 3D information or image during a rotation.

Since the above construction is conventionally used in the field of the present invention, the detailed construction and operation will be omitted.

Therefore, the light emitting diode engaging structure according to an embodiment of the present invention includes a first substrate 106 which is fixed to the light emitting diode rotation frame 102 and includes a controller 104 for controlling a power supply to the light emitting diode 103 and an on and off of the same and a plurality of first pattern portions 105 formed on a surface of the same; and a second substrate 108 in which a second pattern portion 107 electrically connected with the first pattern portion 105 is formed on an upper surface of the same, a plurality of SMD light emitting diodes 103 (molded by a transparent material) capable of combining a RGB color are electrically fixed between the second pattern portions 107, and a printed circuit board (PCB) is electrically connected with the first substrate 106 and is flexibly constituted.

In the drawings, reference numeral 110 represents a contactor which is electrically connected with the brush 109 and is connected to and insulated with respect to the rotary shaft 101a by an insulator for thereby supplying a commercial power to the controller 104.

The construction that the light emitting diodes are engaged to the PCB according to an embodiment of the present invention will be described with reference to the accompanying drawings.

As shown in FIGS. 3 through 5, the second substrate 108 in which a plurality of SMD (surface mounting device) light emitting diodes 103 combined by the RGB colors are provided is electrically connected with the first substrate 106 by a lead welding method. The first pattern portion 105 formed in the first substrate 106 is electrically connected with the second pattern portion 107 formed in the edge portion of the upper surface of the second substrate 108 by a lead welding method. The light emitting diode 103 and the second pattern portion 107 are electrically connected between the second substrate 108 and the second pattern portion 107 by a lead welding method.

Here, since the second substrate 106 is formed of the flexible PCB material, even when the first substrate 106 in which the light emitting diodes 103 are provided is formed in a circular shape, it is possible to easily fix the light emitting diode 103.

The first substrate 106 is integrally fixed to the light emitting diode rotation frame 102 fixed to the rotary shaft 101a of the motor 101 by an engaging member, so that as the motor 101 is driven, the first substrate 106 is rotated.

Therefore, the SMD light emitting diodes 103 engaged on the upper surface of the second substrate 108 fixed to the first substrate 106 are capable of displaying a certain 3D information, graphic processed numerals or images in an atmosphere space based on a previously stored program of the controller 104 in various shapes.

In the present invention, it is not needed to use a certain wire adapted for transferring a certain electrical signal adapted to control the power from the controller 104 and an on and off of the light emitting diodes to the light emitting diodes 103, so that the work process is decreased, and a mass production is possible. Since the light emitting diodes 103 are engaged to the patterned PCB, the luminance of the light is enhanced. It is possible to implement a clear 3D information or image during a rotation. Therefore, in the case that the present invention is commercially adapted to the rotational information display device, it is possible to enhance a reliability of the company.

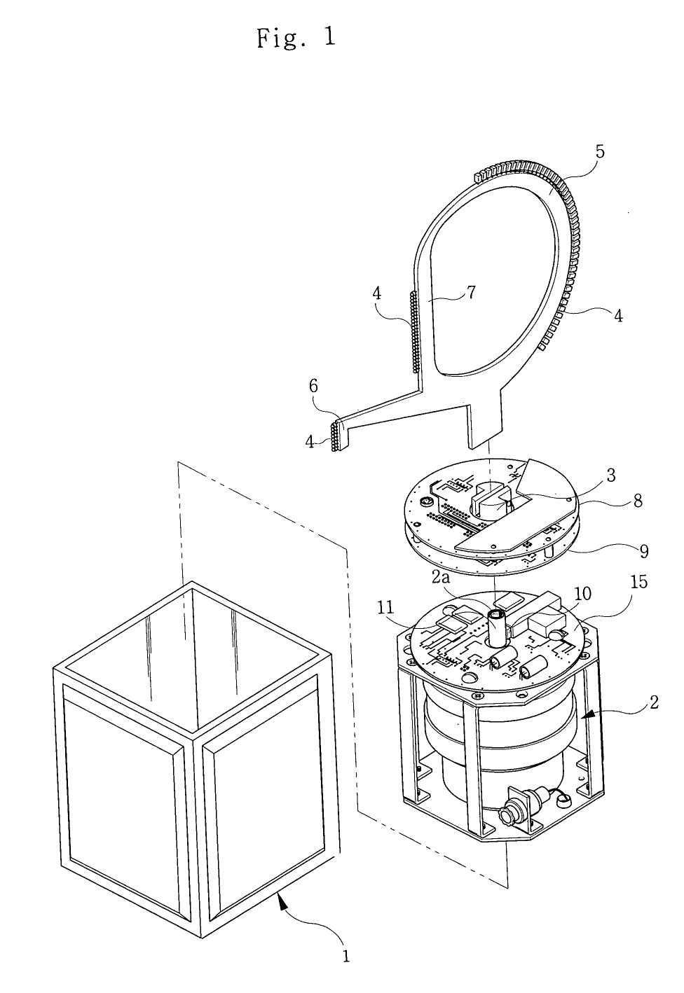

As shown in FIGS. 1, 6 and 7, the light emitting diode fixing structure of the rotational information display device according to another embodiment of the present invention includes a housing 1, a motor 2 installed in the housing and driven when a power is supplied, a light emitting diode rotation frame 3 which is engaged to a rotary shaft 2a of the motor 2 and is rotated, a light emitting diode 4 which is provided in the light emitting diode support fixed to the light emitting diode rotation frame 3 for thereby displaying a certain 3D information in an atmosphere space during a rotation, a second controller 8 which is fixed to the rotary shaft 2a for supplying a power to the light emitting diode 4, a first controller 9 which is connected with the second controller 8 for controlling an on and off of the light emitting diode 4, a third controller 15 for supplying a commercial power to the second controller 8, and a contactor 11 which is insulation-connected with the rotary shaft 2a using a certain insulator for thereby supplying to the power to the second controller 9.

Since the above construction is same as the construction of FIG. 1, the detailed description concerning the construction and operation will be omitted, and the elements same as the construction of FIG. 1 will be given the same reference numerals.

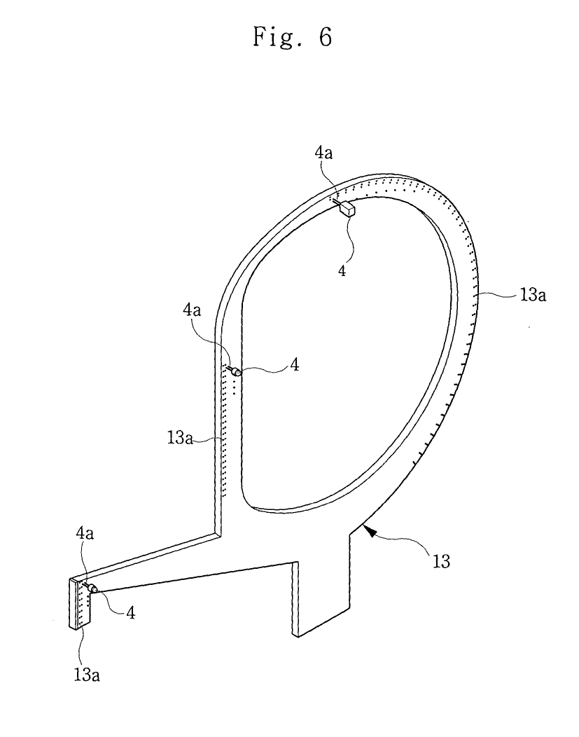

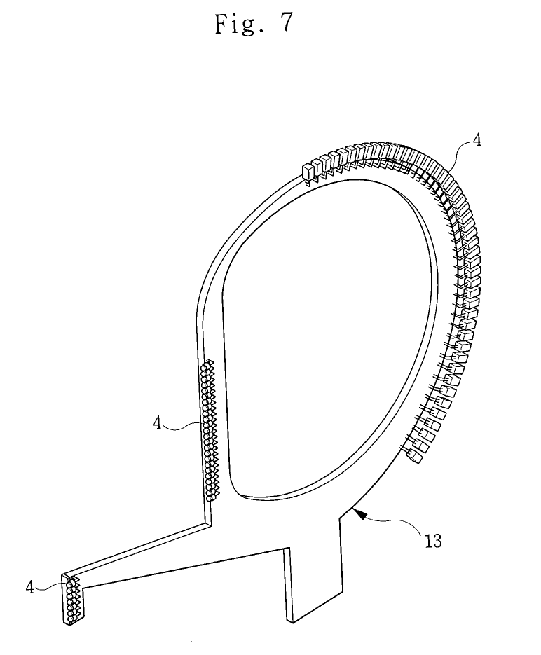

As shown in FIGS. 6 and 7, in the light emitting diode engaging structure according to another embodiment of the present invention, the light emitting diodes 4 are fixed in the patterned PCB 13 electrically connected by the first controller 9 and the contactor (not shown), so that the light emitting diodes 4 and the first controller 9 transfer the signals without a wire.

The construction that the light emitting diodes are engaged to the PCB according to another embodiment of the present invention will be described.

As shown in FIGS. 1, 6 and 7, the light emitting diode rotation frame 3 is integrally engaged to the rotary shaft 2a of the motor 2 by an engaging member, and the patterned PCB 13 is fixed to the light emitting diode rotation frame 3.

At this time, in the light emitting diodes 4 capable of displaying a 3D information or image in an atmosphere space during a rotation by the motor 2, the leads 4a are inserted into the through holes 13a formed in the patterned PCB 13 and are lead-welded at its back surface. The light emitting diodes 4 are bent in an outer direction vertically with respect to the PCB 13.

As the light emitting diodes 4 are directly fixed to the patterned PCB 13, it is not needed to use the light emitting supports for supporting the light emitting diodes 4. Therefore, it is possible to implement an easier fixing work of the light emitting diodes 4, and the work time and work process are decreased, so that a productivity is significantly increased.

As described above, the structure for engaging a light emitting diode of a rotational information display device according to the present invention has the following advantages.

In the present invention, it is not needed to use a wire for connecting the controller adapted to control an on and off of the light emitting diode and the light emitting diodes in such a manner that a plurality of light emitting diodes capable of displaying a 3D information or image in an atmosphere space during a rotation are engaged in the patterned printed circuit board, so that it is possible to decrease the work process, and to significantly decrease the fabrication cost based on a mass production.

In addition, in the present invention, since the light emitting diodes are accurately installed in the set positions of the patterned PCB, it is possible to enhance a luminance of the light emitting diodes and to implement an accurate and clear 3D information or image. Therefore, a reliability of the product is increased.

In addition, a workability is significantly increased by decreasing a work time and work process needed for fixing the light emitting diodes to the patterned PCB.

It is possible to freely implement a 3D image, graphic processed image and character in natural colors using the SMD light emitting diodes combined based on RGB colors as the light emitting diodes. Therefore, it is possible to achieve a desired compatibility with respect to other products.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a rotational information display device which includes a housing, a motor installed in the housing and driven when a power is supplied, a light emitting diode rotation frame engaged to a rotary shaft of the motor, and light emitting diodes installed in the light emitting diode support fixed to the light emitting diode rotation frame for thereby displaying a 3D information or image during a rotation, a structure for engaging a light emitting diode in a rotational information display device, comprising:
a first substrate which is fixed to the light emitting diode rotation frame and includes a controller for controlling a power supply to the light emitting diodes and an on and off operation and a plurality of first pattern portions formed on a surface of the same; and
a second substrate which includes a second pattern portion electrically connected with the first pattern portion, and a plurality of light emitting diodes electrically connected between the second pattern portions, said second substrate being electrically connected with the first substrate.

2. The structure of claim 1, wherein said second substrate is formed of an elastically flexible printed circuit board.

3. The structure of either claim 1 or claim 2, wherein said light emitting diodes engaged on the second substrate are formed of a plurality of SMD light emitting diodes which may be combined based on RGB colors.

4. In a rotational information display device which includes a housing, a motor installed in the housing and driven when a power is supplied, a light emitting diode rotation frame which is engaged to a rotary shaft of the motor and is rotated, light emitting diodes which are provided in the light emitting support fixed to the light emitting diode rotation frame for thereby displaying a 3D information or image in an atmosphere space during a rotation, and a controller fixed to the rotary shaft for controlling an on and off of the light emitting diodes, a structure for engaging a light emitting diode of a rotational information display device, comprising:
a patterned printed circuit board (PCB) which is electrically connected with the controller and fixed to the light emitting diode rotation frame, and in the patterned PCB, the light emitting diodes are inserted into the through holes and are lead-welded in the back surface, so that the power and electrical signal from the controller are transferred to the light emitting diodes.

5. The structure of claim 4, wherein said light emitting diodes engaged on the PCB are formed of a plurality of SMD light emitting diodes which may be combined based on RGB colors.
